(19) United States
(12) Patent Application Publication
(10) Pub. No.: US 2003/0172111 A1
(43) Pub. Date: Sep. 11, 2003

(54) Shadow clients for computer networks

(75) Inventor: Rajugopal R. Gubbi, Fair Oaks, CA (US)

Correspondence Address: James J. Murphy, Esq., Winstead Sechrest & Minick, 5400 Renaissance Tower, 1201 Elm Street, Dallas, TX, 75270, US

(73) Assignee: Cirrus Logic, Inc., Austin, TX (US)

(21) Appl. No.: 10/361,873

(22) Filed: Feb. 10, 2003

Related U.S. Application Data
(63) Continuation of application No. 09/151,545, filed on Sep. 11, 1998.

(51) Int. Cl. G06F 15/16

(52) U.S. Cl. 709/203

(57) ABSTRACT

Within a computer network, a first one of a number of clients may be a consumer of information included within one or more data streams transmitted between a server and one or more others of the clients. However, each of the clients are also communicatively coupled to the server via a command channel independent of these data streams. In some cases, the first client receives the information as the data streams are transmitted from the server to the other clients, while in other cases the first client receives the information as it is being transmitted from the other clients to the server. In addition to the data streams, the first client may exchange additional information with the server. The data streams may be transmitted on a wireless communication link communicatively coupling the server and the clients. However, the first client may receive the information via a communication path separate from the wireless communication link. In some cases the information represents only a portion of the data streams transmitted between the server and the clients. Bandwidth within the network may be allocated by partitioning a communication channel into a number of slots according to bandwidth needs of information consumers and information providers within the network; and sharing at least one of the slots among two of the information consumers within the network.

### RELATED APPLICATIONS

This application is related to the following co-pending applications, all assigned to the assignee of the present application.

Application Ser. No. 09/151,595, entitled “Method And Apparatus For Controlling Communication Within A Computer Network”, filed Sep. 11, 1998, by Rajugopal R. Gubbi.

Application Ser. No. 09/151,579, entitled “Method And Apparatus For Accessing A Computer Network Communication Channel”, filed Sep. 11, 1998, by Rajugopal R. Gubbi.

Application Ser. No. 09/151,452, entitled “Hierarchical Computer Network Architecture”, filed Sep. 11,1998, by Rajugopal R. Gubbi.

Application Ser. No. 09/151,595, entitled “Dynamic Communication Channel Switching For Computer Networks”, filed Sep. 11, 1998, by Rajugopal R. Gubbi.

### FIELD OF THE INVENTION

The present invention relates generally to client-server architectures for computer networks and, in particular, to a scheme for reducing bandwidth requirements for data transmissions within such a network.

### BACKGROUND

Modern computer networks allow for inter-communication between a number of nodes. Communication links transport information between these. However, to date most computer networks have relied on traditional client-server architectures, wherein network clients must each be allocated separate communication channels with the server. Such schemes require significant bandwidth on the communication links where more than only a few clients are present. This need for bandwidth becomes even more apparent where multimedia information is being transmitted between the clients and the server. What is needed, therefore, is a scheme that allows for a reduction in the bandwidth requirements in a computer network.

### SUMMARY OF THE INVENTION

In one embodiment, a computer network includes a server and a number of clients communicatively coupled thereto. A first one of the clients may be a consumer of information included within one or more data streams transmitted between the server and a one or more others of the clients. In some cases, the first client receives the information as the data streams are transmitted from the server to the other clients, while in other cases the first client receives the information as it is being transmitted from the other clients to the server. However, each client is also communicatively coupled to the server via a command channel independent of these data streams. In addition to the data stream, the first client may exchange additional information with the server. In some embodiments, the data stream may be transmitted on a wireless communication link communicatively coupling the server and the clients. However, the first client may receive the information via a communication path separate from the wireless communication link. In some cases the information represents only a portion of the data streams transmitted between the server and the clients.

Further, the first client may be communicatively coupled to one or more subclients, in some cases via a communication path that does not include the data stream transmitted between the server and the second client.

In still further embodiments, bandwidth may be allocated within in a computer network by partitioning a communication channel into a number of slots according to bandwidth needs of information consumers and information providers within the network; and sharing at least one of the slots among two of the information consumers within the network. In such embodiments, one of the two information consumers may be allocated another of slots in addition to the shared slot.

Still other embodiments provide a method of distributing data within a computer network, wherein a first network client is associated with a stream of data transmitted between a server and a second network client. In some cases, the stream of data is transmitted from the second network client to the server, while in other cases the stream of data is transmitted from the server to the second network client. The method may also allow for transmitting information separate from the stream of data between the first network client and the server. Such information may be commands transmitted by the server for the first network client and/or data transmitted by the first network client for the server. The information may be transmitted via a wireless communication link, and, in some cases, may be multimedia information.

Still further embodiments of the present invention provide for sharing one or more data streams among two or more components of a computer network. In general, the computer network may be organized to allow for the exchange information between a server and a number of clients within a communication channel. The sharing of the data streams may then be accomplished by designating a first one of the components as a shadow client of a second one of the components. In some cases, the shadow client may be a peer of the second one of the components within the hierarchy of the computer network. In some embodiments, this sharing includes allowing the shadow client to consume information contained in the one or more data streams addressed to the second of the components. Further, an unshared command channel for the shadow client may be provided within the communication channel. In some cases, the first of the components may be authenticated for access to the one or more data streams prior to being designated as the shadow client. This may involve the use of a request/acknowledge protocol between a server of the computer network and the second component.

These and other features and advantages of the present invention will be apparent from a review of the detailed description and its accompanying drawings that follow.

### BRIEF DESCRIPTION OF THE DRAWINGS

The present invention is illustrated by way of example, and not limitation, in the figures of the accompanying drawings in which:

FIG. 1 illustrates a generalized network structure that is supported by a wireless protocol that is one embodiment of the present invention; and

FIG. 2 illustrates an hierarchical arrangement for the transmission of data within a subnet according to one embodiment of the present invention.

### DETAILED DESCRIPTION

Described herein is a network architecture and related protocols for use between a server and associated network clients. The present scheme is generally applicable to a variety of computer network environments, but finds especially useful application in a computer network which is located in a home environment and which utilizes a wireless communication link between the server and the clients. Thus, the present scheme will be discussed with reference to the particular aspects of a home environment. However, this discussion should in no way be seen to limit the applicability of the present invention to other network environments and the broader spirit and scope of the present invention is recited in the claims which follow this discussion.

As used herein, a “subnet” may describe a cluster of network components which includes a server and several clients associated therewith (e.g., coupled through a wireless communication link). Depending on the context of the discussion, a subnet may also refer to a network that includes a client and one or more subclients associated therewith. In some cases, the term “subnet” is used interchangeably with “cell”. In this scheme, a “client” is a network node linked to the server through a wireless (or other) communication link. Examples of clients include audio/video equipment such as televisions, stereo components, satellite television receivers, cable television distribution nodes, and other household appliances. A server may be a separate computer that controls the communications link, however, in other cases the server may be embodied as an add-on card or other component attached to a host computer (e.g., a personal computer). Subclients may include keyboards, joysticks, remote control devices, multi-dimensional input devices, cursor control devices, display units and/or other input and/or output devices associated with a particular client.

Another term used throughout the following discussion is “channel”. A channel is defined as the combination of a transmission frequency (more properly a transmission frequency band) and a pseudo-random (PN) code used in a spread spectrum communication scheme. In general, a number of available frequencies and PN codes may provide a number of available channels within a subnet. As will be described in greater detail below, servers and clients are capable of searching through the available channels to find a desirable channel over which to communicate with one another. Table 1 below illustrates an exemplary channel plan according to this scheme.

TABLE 1

| | |
|---|---|
| Available | Available PN Codes |

| Frequency Banks | PN Code 1 | PN Code 2 | . . . | PN Code n |
|---|---|---|---|---|
| Frequency Band 1 | Channel 1₁ | Channel 1₂ | . . . | Channel 1ₙ |
| Frequency Band 2 | Channel 2₁ | Channel 2₂ | . . . | Channel 2ₙ |
| Frequency Band N | Channel N₁ | Channel N₂ | . . . | Channel Nₙ |

In one embodiment, a channel plan using two frequency bands is adopted and details of channel selection within such a scheme is discussed in greater detail below.

With this terminology in mind, the present scheme will be discussed first with reference to an exemplary network topology that may employ a wireless communication link and an associated communication protocol. Second, network operations that make use of an hierarchical structure for data transmitted within a communication channel supported on the wireless link will be described.

A. Network Topology

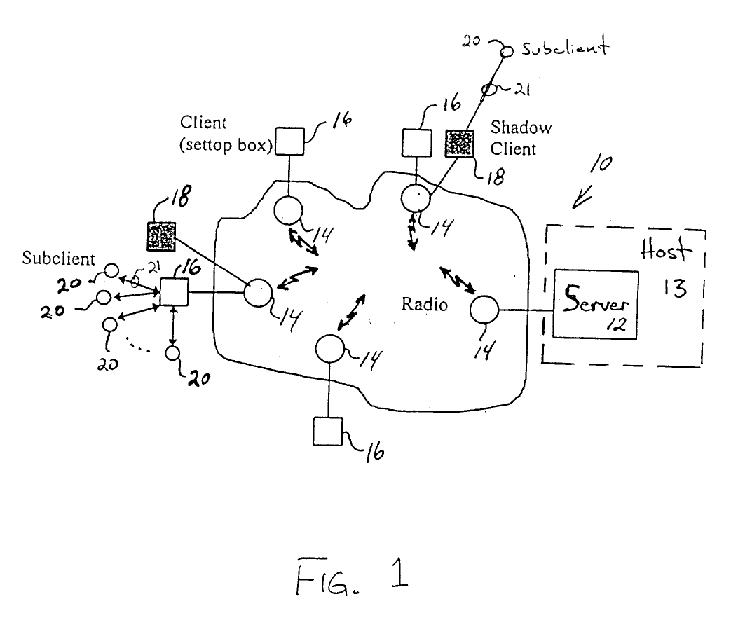

The generalization of the network structure that is supported by the present scheme is shown in FIG. 1. Subnet 10 includes a server 12. As indicated above, server 12 may be a stand-alone unit or, more likely, an attachment card for a personal computer, which serves as a host 13 for the server. Server 12 has an associated radio 14, which is used to couple server 12 wirelessly to the other nodes of subnet 10. The wireless link generally supports both high and low bandwidth data channels and a command channel.

Also included in subnet 10 are a number of clients 16, some of which have shadow clients 18 associated therewith. Each client 16 has an associated radio 14, which is used to communicate with server 12, and some clients 16 may have associated subclients 20. A client 16 and its associated subclients 20 may communicate with one another via communication links 21, which may be wireless (e.g., infra-red, ultrasonic, spread spectrum, etc.) communication links.

Shadow clients 18 may be regarded as network components that can be associated with a particular stream of data (e.g., audio and/or video data) from server 12 and/or a client 16. That is, a shadow client 18 can receive data that is being transmitted to/from its principal client 16 from/to server 12. Any one client 16 may be associated with one or more shadow clients 18 (i.e., shadow clients 18 may be organized as a group for a particular principal client 16). In some cases, multiple shadow clients 18 may be associated with the same principal client 16, but each shadow client 18 may consume different data streams transmitted on a common link (e.g., where a client 16 is an audio/video consumer or provider, its shadow clients may be audio-only consumers and/or video-only consumers and such shadow clients would only consume portions of the data transmitted to/from the principal client). A shadow client 18, apart from consuming common data, may also consume other, independent data such as music (i.e., audio data) from a host computer (i.e., server 12) and/or interrupting video from a security camera. To accommodate these functions, shadow clients 18 may have their own data and/or command channels designated in the communication link with server 12. Shadow clients 18 may also have their own subclients. In short, a shadow client 18 may be functionally similar to any other network client 16, but will further be defined by the sharing of at least one stream of data (e.g., audio, video or other) with another client 16.

Thus, the use of shadow clients 18 allows for the sharing of one or more data streams between two or more network devices. For example, a client 16 and its associated shadow client(s) 18 may share one or more data stream(s) transmitted to/from server 12. Such a scheme differs from conventional broadcast or multicast operations in a variety of ways. First, all information consumers (i.e., those receiving a data stream) are authenticated by one another. That is, when a network component is designated as a shadow client to another client 16 or group of clients and/or subclients 20 and/or shadow clients 18, each network component in the group is informed (e.g., through transmissions from server 12) of the addition of the new shadow client and transmits an acknowledgement thereto. This request/acknowledge scheme allows a client or group to determine whether the network component seeking shadow client status is authorized to receive the data stream being requested. For example, some data streams may only be suitable for transmission/reception by network components having certain access privileges or features. If an unauthorized network component seeks access to a data stream which it does not have access privileges to, the request/acknowledge protocol may be used to deny such access.

In addition, unlike conventional broadcast or multicast schemes, the shadow client protocol does not require the data packets which make up the shared data stream to be addressed to multiple network components. Instead, the packets may be addressed to the primary client 16 or group and, during setup, shadow client devices will be instructed to read/consume packets having that address. Finally, as indicated above, all shadow clients 18 maintain separate, unshared command channels with server 12 and may further be providers/consumers of unshared data streams/channels.

By providing the shadow clients 18 then, peer-to-peer communication within the network may be realized. That is, although communications within the network are established between clients 16 and server 12 (as described in detail below with reference to a communication hierarchy), shadow clients 18 allow for communication between peer network devices without requiring additional bandwidth therefor. Thus, multiple video consumers may receive the same video feed from server 12 or a client 16, without additional bandwidth requirements. Also, two or more clients 16 may be shadow clients of one another, allowing for the exchange of information between those components as each exchanges information with server 12.

Each subnet 10 may be regarded as a network arranged in an hierarchical fashion with various levels of the hierarchy corresponding to levels at which inter-network component communication occurs. At a highest level of the hierarchy exists the server 12 (and/or its associated host 13) which communicates with various clients 16 via the wireless radio channel. At other, lower levels of the hierarchy the clients 16 communicate with their various subclients 20 using, for example, wired communication links or wireless communication links such as infrared links. This hierarchy may also be described in terms of a three-tier structure as illustrated in Table 2 below. As indicated, devices may be added to any level of the network online (e.g., hot insertion during other network operations).

TABLE 2

| Tier/Level | Device(s) | Channel Type | Connection Time |
|---|---|---|---|
| 1 | Subclients (e.g., | Wireless (e.g., | Online |
| | keyboards, mice, | infrared) or Wired | |
| | joysticks, and/or | | |
| | other input/output | | |
| | devices) | | |
| 2 | Clients (e.g., set- | Wireless (e.g., | Online |
| | top controllers) | radio (RF) | |
| | | channels) | |
| 3 | Server (and/or | Wireless (e.g.,., | Online |
| | host) | radio (RF) | |
| | | channels) | |

In general, subnet 10 may include the single server 12 and literally any number of clients 16. However, the number of simultaneous clients 16 supported depends on their forward and backward bandwidth requirements. In one embodiment, the wireless link which couples server 12 and clients 16 (e.g., via radios 14) is a full duplex, 10 Mbps link. In other embodiments, the wireless link is a half-duplex, 4 Mbps link. Still other embodiments allow for half-duplex or full-duplex links with different bandwidths.

Radios 14 are preferably configured to allow for intra-subnet communication within a typical home environment. In one embodiment, this means that radios 14 are capable of establishing and maintaining communications within a particular cell area. In one embodiment, a typical cell area may be approximately 100′×80′×30′, allowing for communication throughout a typical home environment. The wireless link supported by radios 14 preferably provides at least two separate frequency spaces to support two overlapping cells. Thus, radios 14 can operate in one of the available frequency bands. Within the same frequency band, individual subnets (comprised of a server 12 and a number of clients 16 and, optionally, shadow clients 18 and subclients 20) preferably employ code division multiple access (CDMA) communication techniques for intra-subnet exchanges of information. For half-duplex operation, forward and reverse channels over the same frequency band (which employ the same CDMA pseudo-random (PN) code) may utilize dynamically adjustable time division multiplexing (TDMA) to differentiate between transmissions from server 12 and clients 16. Error correction (e.g., using Reed-Solomon encoders/decoders) and data encryption techniques may be employed to provide added robustness and security against eavesdropping.

For one embodiment, e.g., where half-duplex radio communication is used, the communication link may be organized in a slotted link structure (described in greater detail below), with dynamic slot assignment. Such a structure will support point-to-point connections within subnet 10 and slot sizes may be re-negotiable within a session. That is bandwidth to each client 16 and any associated subclients 20 and/or shadow clients 18 may be continuously policed for any under or over utilization of that bandwidth. Bandwidth renegotiations, as may be required whenever a new client 16, subclient 20 and/or shadow client 18 comes on-line, are accommodated on the fly.

The network architecture allows a number of network components (e.g., server 12 clients 16, shadow clients 18 and subclients 20) to be arranged in an hierarchical fashion. At one level of the hierarchy, server 12 and clients 16 (and/or their associated subclients 18) operate to exchange information, such as multimedia data. At another level of the hierarchy, clients 16 communicate with their respective subclients 20 (and/or shadow clients 18) and may exchange information, such as commands that originate/terminate with server 12 or other data. At each level of this network hierarchy, the individual network components are communicatively coupled to one another through communication links operative at that level of the hierarchy. For example, discussed in the next section is a protocol operative at the highest level of the hierarchy (i.e., between server 12 and clients 16/subclients 18), which supports dynamic addition of new network components at any level of the hierarchy, according to bandwidth requirements thereof with respect to a communication channel employed at the highest level of the hierarchy. Communication at a lower level of the hierarchy (e.g., between clients 16 and their associated subclients 20) may make use of a similar protocol or any other convenient communication protocol according to the operations performed by the client and its subclients. For example, existing communication protocols for the exchange of information across wireless (e.g., infrared) or wired communication links between subclients and their associated clients may be supported, with any such data being subsequently encapsulated (and/or reformatted if necessary) within data packets to be exchanged according to the protocol discussed below when that information is to be transmitted between a client 16 and server 12.

B. Network Operations

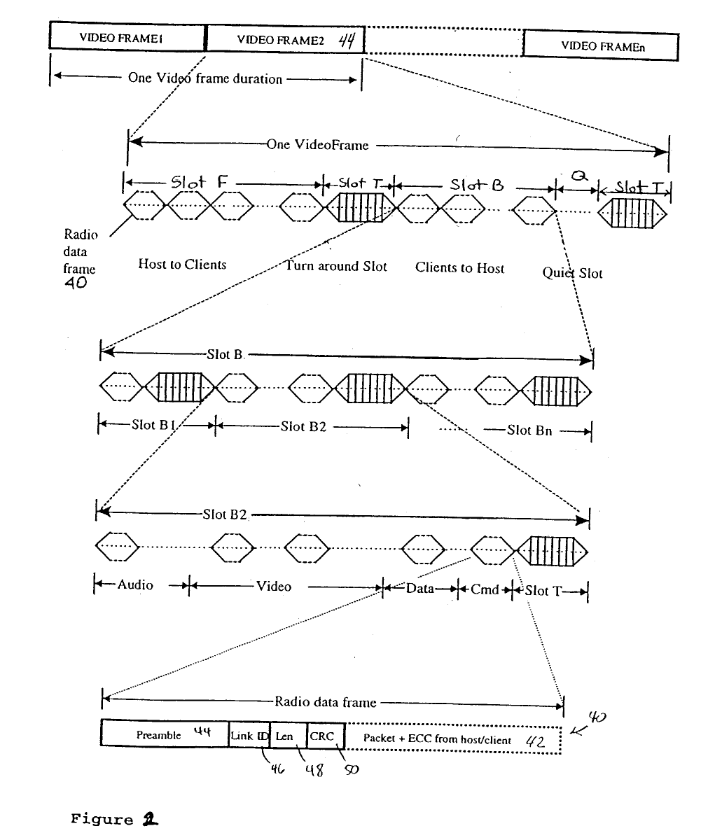

Having thus described the basic topology of a network that supports the present scheme, exemplary operations (e.g., for half-duplex operations) for the network will be described. As shown in FIG. 2, these operations utilize an hierarchical arrangement for the transmission of real time, multimedia data (e.g., as frames) within a subnet 10. At the highest level within a channel, forward (F) and backward or reverse (B) slots of fixed (but negotiable) time duration are provided within each frame transmission period. During forward time slots F, server 12 may transmit video and/or audio data and/or commands to clients 16 and/or associated shadow clients 18, which are placed in a listening mode. During reverse time slots B, server 12 listens to transmissions from the clients 16/shadow clients 18. Such transmissions may include audio, video or other data and/or commands from a client 16/shadow client 18 or an associated subclient 20. At the second level of the hierarchy, each transmission slot (forward or reverse) is made up of one or more radio data frames 40 of variable length. Finally, at the lowest level of the hierarchy, each radio data frame 40 is comprised of server/client data packets 42, which may be of variable length.

Each radio data frame 40 is made up of one server/client data packet 42 and its associated ECC bits. The ECC bits may be used to simplify the detection of the beginning and ending of data packets at the receive side. Variable length framing is preferred over constant length framing in order to allow smaller frame lengths during severe channel conditions and vice-versa. This adds to channel robustness and bandwidth savings. Although variable length frames may be used, however, the ECC block lengths are preferably fixed. Hence, whenever the data packet length is less than the ECC block length, the ECC block may be truncated (e.g., using conventional virtual zero techniques). Similar procedures may be adopted for the last block of ECC bits when the data packet is larger.

As shown in the illustration, each radio data frame 40 includes a preamble 44, which is used to synchronize PN generators of the transmitter and the receiver. Link ID 46 is a field of fixed length (e.g., 16 bits long for one embodiment), and is unique to the link, thus identifying a particular subnet 10. Data from the server 12/client 16/shadow client 18 is of variable length as indicated by a length field 48. Cyclic redundancy check (CRC) bits 50 may be used for error detection/correction in the conventional fashion.

For the illustrated embodiment then, each frame 44 (e.g., of duration 33.33 msec for one embodiment) is divided into a forward slot F, a backward slot B, a quiet slot Q and a number of radio turn around slots T. Slot F is meant for server 12-to-clients 16/shadow clients 18 communication. Slot B is time shared among a number of mini-slots B₁, B₂, etc., which are assigned by server 12 to the individual clients 16/shadow clients 18 for their respective transmissions to the server 12. Each mini-slot B₁, B₂, etc. includes a time for transmitting audio, video, voice, lossy data (i.e., data that may be encoded/decoded using lossy techniques or that can tolerate the loss of some packets during transmission/reception), lossless data (i.e., data that is encoded/decoded using lossless techniques or that cannot tolerate the loss of any packets during transmission/reception), low bandwidth data and/or command (Cmd.) packets. Slot Q is left quiet so that a new client may insert a request packet when the new client seeks to log-in to the subnet 10. Slots T appear between any change from transmit to receive and vice-versa, and are meant to accommodate individual radios' turn around time (i.e., the time when a half-duplex radio 14 switches from transmit to receive operation or vice-versa). The time duration of each of these slots and mini-slots may be dynamically altered through renegotiations between the server 12 and the clients 16/shadow clients 18 so as to achieve the best possible bandwidth utilization for the channel. Note that where full duplex radios are employed, each directional slot (i.e., F and B) may be full-time in one direction, with no radio turn around slots required.

Forward and backward bandwidth allocation depends on the data handled by the clients 16/shadow clients 18. If a client 16/shadow client 18 is a video consumer, for example a television or monitor, then a large forward bandwidth is allocated for that component. Similarly if a client 16/shadow client 18 is a video generator, for example a video camcorder, then a large reverse bandwidth is allocated to that particular component. The server 12 maintains a dynamic table (e.g., in memory at server 12 or host 13), which includes forward and backward bandwidth requirements of all on-line network components. This information may be used when determining whether a new connection may be granted to a new client/shadow client/subclient. For example, if a new client 16 requires more than the available bandwidth in either direction, server 12 may reject the connection request. The bandwidth requirement (or allocation) information may also be used in deciding how many radio packets a particular client 16 needs to wait before starting to transmit its packets to the server 12. Additionally, whenever the channel conditions change, it is possible to increase/reduce error correction coding (ECC) to cope with the new channel conditions. Hence, depending on whether the information rate at the source is altered, it may require a dynamic change to the forward and backward bandwidth allocation.

Time slot synchronization between the server 12 and the clients 16 is addressed for four network operational situations: when a client wakes up; when a new client comes online; when the channel is changed; and when a client goes absent or shuts down in co-pending application Ser. No. ______, entitled “Method And Apparatus For Controlling Communication Within A Computer Network”, filed ______, 1998, by Rajugopal R. Gubbi and assigned to the Assignee of the present invention, which is hereby incorporated by reference in its entirety. Briefly, when a client 16 (hereafter, the discussions relating to clients 16 should be understood to apply equally for associated shadow clients 18) wakes up, it starts out in a receive mode and listens to a channel. If the client 16 detects activity on the channel, it waits for slot Q and sends a connection request in that slot to the server 12. In response, server 12 may verify the request and then negotiate a bandwidth allocation with the client 16. Following these negotiations, the server 12 and client 16 may initiate normal communications.

The above discussion assumed that the client 16 awoke to find a channel in use. However, it is possible that when the client 16 wakes up, the channel will not be busy. In such cases, the client 16 may transmit a connection request, hoping that the server 12 will respond. If no response is received, the client 16 may change channels and try again. This process may repeat for all available channels until the server 12 is found. If no response is received after all channels have been searched, the client 16 may inform a user that no server is available.

During network operations, channel switching may be required when either the server 12 or one of the clients 16/shadow clients 18 experiences serious channel impairments (e.g., despite antenna diversity and/or a higher degree of ECC). In such scenarios, the server 12 searches for another channel, in an attempt to find a channel where the interference is less severe. If it determines that the new channel offers better prospects for communication operations, server 12 initiates a channel change or switch operation. These operations are described in detail in the above-referenced co-pending application.

When a client 16/shadow client 18 wants to disconnect, a disconnect request is sent to server 12 and the client 16/shadow client 18 shuts off after receiving a an acknowledgement. The server 12 then deletes the client/shadow client from its list of online components. This allows the newly freed bandwidth to be reallocated.

Thus, server 12 carries out dynamic network management, which includes bandwidth allocation; network policing for bandwidth utilization (also reported to the host computer 13) and re-negotiations; on-line network component list maintenance; and channel selection/changing. Clients, shadow clients and/or subclients may be inserted into the network on-line (so-called hot insertion), provided bandwidth on the communication link is available.

Thus, a scheme for providing shadow clients within computer networks has been described. Although discussed with reference to certain illustrated embodiments, the present invention should not be limited thereby. Instead, the present invention should only be measured in terms of the claims that follow.

1. A computer network, comprising:
a server;
a plurality of principal clients communicatively coupled with the server via a communications link and via a separate command channel, the command channel being independent of one or more data streams addressed to the plurality of principal clients and transmitted between the server and the principal clients via the communications link; and
at least one shadow client associated with one of the plurality of principal clients, the shadow client to read and/or consume a portion of data included within the one or more data streams addressed to the one of the plurality of principal clients.

2. (Twice Amended) The computer network of claim 1 wherein the shadow client receives the data as the data streams are being transmitted from the server to the principal clients.

3. (Amended) The computer network of claim 1 wherein the shadow client receives the data as the data streams are being transmitted from the principal clients to the server.

4. (Twice Amended) The computer network of claim 1 wherein the shadow client exchanges additional data with the server independently of the data streams being transmitted between the server and the principal clients.

5. (Amended) The computer network of claim 1 wherein the data streams are transmitted on a wireless communication link communicatively coupling the server and the principal clients.

6. (Amended) The computer network of claim 5 wherein the shadow client receives the information via a communication path separate from the wireless communication link.
Please cancel claim 7.

8. (Twice Amended) The computer network of claim 1 wherein the data represents only a portion of the data streams being transmitted between the server and the principal clients.

9. (Amended) The computer network of claim 1 wherein the shadow client is further communicatively coupled to one or more subclients.

10. (Twice Amended) The computer network of claim 9 wherein the one or more subclients are communicatively coupled to the shadow client via a communication path that does not include the data streams being transmitted between the server and the principal clients.
Please cancel claim 11 and 12—November Amendment '00

13. (Three Times Amended) A method of distributing data within a computer network, the method comprising:
associating one or more shadow clients with a stream of data transmitted between a server and a one or more other principal clients, wherein the stream of data is not addressed to the shadow client.

14. (Amended) The method of claim 13, wherein the stream of data is transmitted from the principal clients to the server.

15. (Twice Amended) The method of claim 13 wherein the stream of data is transmitted from the server to the principal clients.

16. (Twice Amended) The method of claim 13, further comprising:
transmitting data between the shadow client and the server, which data is separate from the stream of data transmitted between the server and the one or more principal clients.

17. (Twice Amended) The method of claim 16 wherein the data separate from the stream of data transmitted between the server and the one or more principal clients comprises commands transmitted by the server for the shadow client.

18. (Twice Amended) The method of claim 17 wherein the data separate from the stream of data transmitted between the server and the one or more principal clients further comprises commands transmitted by the shadow client for the server.

19. (Twice Amended) The method of claim 16 wherein the data separate from the stream of data transmitted between the server and the one or more principal clients is transmitted via a wireless communication link.

20. (Twice Amended) The method of claim 19 wherein the data separate from the stream of data transmitted between the server and the one or more principal clients comprises multimedia data.

21. (Four Times Amended) A method, comprising:
designating, as a principal client, one or more of a plurality of components of a computer network, the network organized to allow for the exchange of data within a communication channel between a server and the plurality of components;
designating, as a shadow client, one or more of the plurality of network components within the communication channel; and
selectively sharing with the one or more shadow clients one or more data streams addressed to the one or more principal clients, the one or more data streams transmitted between the one or more principal clients and the server.

22. (Twice Amended) The method of claim 21 wherein the shadow client is a peer of the principal client within the hierarchy of the computer network.

23. (Twice Amended) The method of claim 21 wherein said selectively sharing with the one or more shadow clients one or more data streams addressed to the one or more principal clients, comprises allowing the shadow client to consume data contained in the one or more data streams addressed to the principal clients using the principal client's address.

24. The method of claim 21 further comprising providing an unshared command channel for the shadow client within the communication channel.

25. The method of claim 21 wherein the first of the components is authenticated for access to the one or more data streams prior to being designated as the shadow client.

26. The method of claim 25 wherein the authentication comprises a request/acknowledge protocol between a server of the computer network and the second component.

27. The computer network of claim 1 wherein a first principal client is a shadow client of a second principal client.

28. The computer network of claim 1 wherein the portion of data is common data.

29. The computer network of claim 1 wherein the portion of data is independent data.
